(19) United States
(12) Patent Application Publication
(10) Pub. No.: US 2026/0203585 A1
(43) Pub. Date: Jul. 16, 2026

(54) PREVENTION OF FAILURE OF PROBLEMATIC DATA STORAGE DEVICES

(71) Applicant: INTERNATIONAL BUSINESS MACHINES CORPORATION, ARMONK, NY (US)

(72) Inventors: Ze Ming Zhao, Beijing (CN); FAN JING Meng, Beijing (CN); Xiao Tian Xu, Beijing (CN); Hua Ye, Beijing (CN); Hong Xin Hou, Shanghai (CN); Zhi E Zhang, Beijing (CN)

(21) Appl. No.: 19/024,523

(22) Filed: Jan. 16, 2025

(51) Int. Cl. G06N 3/084; G06N 3/045

(52) U.S. Cl. CPC G06N 3/084; G06N 3/045

(57) ABSTRACT

A method and computer program product for preventing failure of problematic data storage devices (DSDs), using trained neural network hidden layer (NNHL) models and training the NNHL models. A data storage devices (DSD) parameter set is received. A location of each of problematic DSD is identified. An environmental parameter set is received. A trained NNHL model is executed, using the DSD parameter set and the environmental parameter set as input, to predict and output whether each problematic DSDs will fail or will not fail. In response to the NNHL model predicting and outputting that the at least one problematic DSD will fail, action is taken to change each problematic environmental parameter at the identified locations to have an environmental parameter value that does not exceed a respective specified environmental parameter threshold.

### BACKGROUND

The present invention relates to failure of data storage devices, and more specifically, to prevention of failure of problematic data storage devices by using neural network hidden layer models.

### SUMMARY

Embodiments of the present invention provide a method for training multiple neural network hidden layer (NNHL) models to predict a failure probability of data storage devices (DSDs). For each NNHL model, one or more processors of a computer system receive 1 training data comprising multiple sets of training data, each set of training data comprising: (i) a DSD parameter set comprising one or more problematic DSDs, one or more abnormal DSD parameters respectively associated with each problematic DSD, and an abnormal DSD parameter value that exceeds a respective specified DSD parameter threshold for each abnormal DSD parameter, (ii) an environmental parameter set comprising one or more problematic environmental parameters and an abnormal environmental parameter value outside of specified range of acceptable values for each problematic environmental parameter at an identified location of each problematic DSD, and (iii) Fₜ=1 or 0 for each problematic DSD that failed or did not fail, respectively. For each NNHL model, the one or more processors train, using the training data, the NNHL model to predict Fₚ=1 or 0 for each problematic DSD predicted to fail or not fail, respectively, said training comprising minimizing a loss function, using backpropagation, with respect to deviations of Fₚ from Fₜ for each problematic DSD. 1 Each NNHL model is specific to a unique DSD brand and model, a unique DSD brand, a unique range of DSD storage capacity, a unique range of DSD power consumption, or a unique DSD type selected from the group consisting of hard disk drives, solid state devices, optical disc drives, and tape drives.

Embodiments of the present invention provide a method and a computer program product for 1 preventing failure of problematic data storage devices (DSDs). One or more processors of a computer system receive, 1 from a DSD monitoring system that is included within DSDs and monitors the DSDs, a DSD parameter set comprising one or more problematic DSDs, one or more abnormal DSD parameters respectively associated with each problematic DSD, and an abnormal DSD parameter value that exceeds a respective specified DSD parameter threshold for each abnormal DSD parameter. The 1 one or more processors identify a location of each problematic DSD. The 1 one or more processors receive, from environmental sensors, an environmental parameter set comprising one or more problematic environmental parameters characterized by an abnormal environmental parameter value outside of specified range of acceptable values for each problematic environmental parameter at the identified location of each problematic DSD. The 1 one or more processors execute 1 a trained neural network hidden layer (NNHL) model, using the DSD parameter set and the environmental parameter set as input, to predict and output whether each of the one or more problematic DSDs will fail or will not fail, wherein executing the trained NNHL model comprises predicting and outputting that at least one problematic DSD of the one or more problematic DSDs will fail. 1 In response to said NNHL model predicting and outputting that the at least one problematic DSD will fail, the one or more processors take action to change each problematic environmental parameter at the identified locations to have an environmental parameter value that does not exceed the respective specified environmental parameter threshold.

### BRIEF DESCRIPTION OF THE DRAWINGS

FIG. 1 depicts a computing environment which contains an example of an environment for the execution of at least some of the computer code involved in performing the inventive methods, in accordance with embodiments of the present invention.

FIG. 2 is a computer architecture, in accordance with embodiments of the present invention.

FIG. 3 is a flow chart for training multiple neural network hidden layers (NNHLs), in accordance with embodiments of the present invention.

FIG. 4 is a flow chart of a process that uses backpropagation to minimize the loss function in a backpropagation step of FIG. 3, in accordance with embodiments of the present invention.

FIG. 5 is a flow chart describing a method for preventing failure of problematic data storage devices (DSDs), in accordance with embodiments of the present invention.

FIG. 6 illustrates a computer system, in accordance with embodiments of the present invention.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

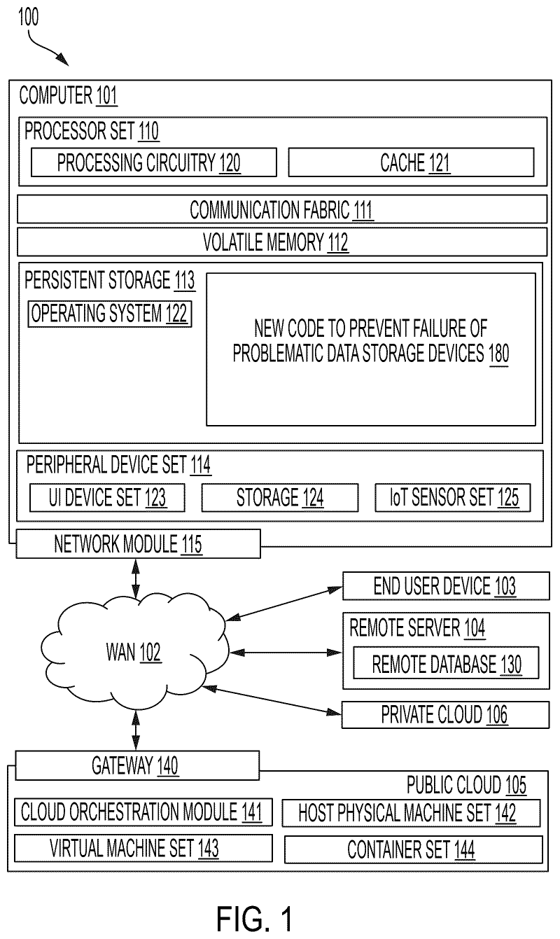

FIG. 1 depicts a computing environment 100 which contains an example of an environment for the execution of at least some of the computer code involved in performing the inventive methods, in accordance with embodiments of the present invention. Such computer code includes new code to prevent failure of problematic data storage devices 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

S.M.A.R.T. (Self-Monitoring, Analysis, and Reporting Technology) (hereinafter, “SMART”) is a monitoring system included in hard drives (HDDs) and solid-state drives (SSDs) to detect and report various indicators of drive health and potential failure. Under some circumstances, SMART may assist in predict hardware failures before the failures occur, allowing users or systems to take preventive measures, such as backing up data or replacing the drive.

Accordingly, SMART tracks various parameters, such as temperature of HDDs and/or SSDs, read/write error rates, spin-up time, and reallocated sector count. SMART assigns a parameter threshold to each parameter. Violating parameters, which are parameters having a parameter value that exceeds the parameter threshold, may be indicative of potential failure relating to the violating parameters and may trigger a warning.

SMART logs parameter deviations and can alert administrators or users through software tools in response to the parameter violations having been detected, which would provide an early warning for of potential failure of the HDDs and/or SSDs.

The parameters monitored by SMART include, inter alia, temperature of HDDs and/or SSDs, read/write error rates, rotational speed, seek error rates, sector reallocation count, spin retry count, power-on hours, cyclic redundancy check (CRC) error count, uncorrectable sector count (number of sectors with errors that cannot be corrected), and wear level count for SSDs (flash memory wear due to write/erase cycles).

However, SMART is only indicative of potential issues and cannot be directly relied upon as a basis for detecting abnormalities. The current anomaly detection requires administrators to monitor the changes in SMART values regularly, use experience of the administrators to determine if any abnormalities have occurred, analyze the corresponding logs, and take appropriate actions (observation, replacement, reconnection, etc.).

Although SMART is a standard, there are variations in the supported features among different brand models. Missing features will impact the accuracy of a unified model and the sample sizes of SMART data are highly imbalanced. Using all samples leads to data skewness. Reducing features for a unified model will lead to unnecessary accuracy loss, especially for a model with large amounts data.

The performance of HDDs and SSDs is influenced by the specific brands and models used with imbalanced data and different supported features for different models. Thus, developing a single predictive model for HDD and/or SSD failure that is universally compatible with all variations is inefficient.

The SMART data of HDDs and SSDs monitored by SMART are fragmented and lack integration, which impairs rapid decision making in response to detection of potential HDD and/or SSD failures.

The response to detection of HDD and/or SSD abnormalities currently relies on manual analysis, manual decision and manual operations, and thus lacks automation.

SMART data does not provide a comprehensive reflection of the overall health status of a HDD and/or a SSD and cannot identify a probable cause of potential failure relating to HDD and/or SSD parameters violating the parameter thresholds assigned to each parameter by SMART.

Embodiments of the present invention utilize data from environmental sensors that monitor environmental parameters that may cause, or be related to, failure of data storage devices (DSDs) that include, inter alia, hard disk drives (HDDs), solid state devices (SSDs), optical disc drives (ODDs), and tape drives (TDs). The environmental sensors may include smart meters in each line of racks.

The environmental parameters monitored by the environmental sensors include atmospheric environmental parameters and non-atmospheric environmental parameters.

The atmospheric environmental parameters include, inter alia, air temperature, air humidity, air quality, and ear dust composition.

Air quality, which is indicative of air pollution, may be measured by the U.S. Air Quality Index (AQI). The higher the AQI value, the greater the level of air pollution.

The atmospheric environmental parameters can cause creep corrosion of printed circuit bords (PCBs) and other information technology (IT) equipment.

The non-atmospheric environmental parameters include, inter alia, radio interference, neutral voltage, ground resistance, static electricity, physical vibration, and unstable voltage.

Each environmental parameter is assigned an environmental parameter threshold. A 1 problematic environmental parameter has an abnormal environmental parameter value outside of specified range of acceptable values for each problematic environmental parameter at an identified location of each problematic DSD. A problematic DSD has an abnormal DSD parameter value that exceeds a specified DSD parameter threshold for one or more abnormal DSD parameters.

Adverse impacts relating to problematic environmental parameters may include, inter alia, slow but irreversible damage to DSDs having abnormal DSD parameter values and to other DSDs located adjacent to the DSDs having abnormal DSD parameter values.

Embodiments of the present invention utilize neural network hidden layer (NNHL) models to predict failure of data storage devices (DSDs), utilizing abnormal DSD parameters and abnormal environmental parameters. A neural network hidden layer model is a neural network model having one or more hidden layers.

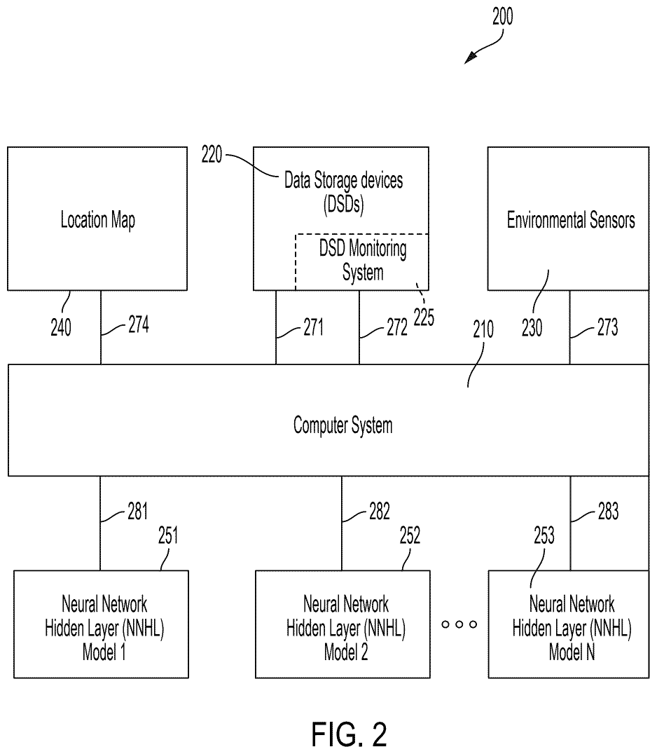

FIG. 2 is a computer architecture 200, in accordance with embodiments of the present invention.

The computer architecture 200 comprises a computer system 210, data storge devices (DSDs) 220 which includes a DSD monitoring system 225, environmental sensors 230, a location map 240, and neural network hidden layer (NNHL) models including NNHL Model 1, NNHL Model 2 252, . . . , NNHL Model N 253. The computer system 210 is linked to: the data storge devices (DSDs) 220 via communication link 271, the DSD monitoring system 225 via communication link 272, the environmental sensors 230 via communication link 273, the location map 240 via communication link 274, and NNHL Model 1 251 via communication link 281, NNHL Model 2 252 via communication link 282, . . . , NNHL Model N 253 via communication link 283.

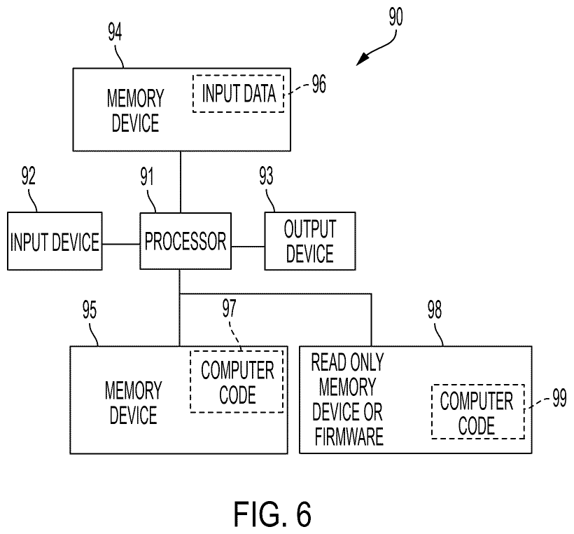

The computer system 210 is structured in accordance with computing environment 100 of FIG. 1 or the computer system 90 of FIG. 6.

The data storage devices (DSDs) 220 include, inter alia, hard disk drives (HDDs), solid state devices (SSDs), optical disc drives (ODDs), and tape drives (TDs).

The DSD Monitoring System 225 monitors the DSDs 220 and may comprise, inter alia, the Self-Monitoring, Analysis, and Reporting Technology (S.M.A.R.T.).

The environmental sensors 230 monitor environmental parameters at a location of each DSD of the DSDs 220. The locations of the DSDs are different locations that are specific to each DSD and are distinct from each other or from one another.

The location map 240 contains the locations of each DSD of the DSDs 220 and is stored within a data structure (e.g., a database table) located in data store.

Each NNHL model of NNHL models 1, 2, . . . , N is 1 specific to a unique DSD brand and model, a unique DSD brand, a unique range of DSD storage capacity, a unique range of DSD power consumption, or a unique DSD type selected from the group consisting of hard disk drives, solid state devices, optical disc drives, and tape drives.

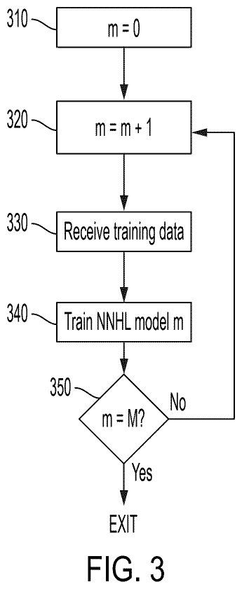

FIG. 3 is a flow chart for training multiple neural network hidden layers (NNHLs), in accordance with embodiments of the present invention. The multiple NNHL models comprise M NNHL models, wherein M is at least 2. The flow chart of FIG. 3 includes steps 310-350.

Step 310 initializes an NNHL model index m to zero.

Steps 220-250 are an iteration of an iterative process of M iterations.

Step 320 increments m by 1.

Steps 330 receives training data for NNHL model m. The 1 training data for NNHL model m comprises multiple sets of training data. Each set of training data comprises: (i) a DSD parameter set comprising one or more problematic DSDs, one or more abnormal DSD parameters respectively associated with each problematic DSD, and an abnormal DSD parameter value that exceeds a respective specified DSD parameter threshold for each abnormal DSD parameter, (ii) an environmental parameter set comprising one or more problematic environmental parameters and an abnormal environmental parameter value outside of specified range of acceptable values for each problematic environmental parameter at an identified location of each problematic DSD, and (iii) Fₜ=1 or 0 for each problematic DSD that failed or did not fail, respectively.

Step 340 trains, using the training data received in step 330, the NNHL model m to predict Fₚ=1 or 0 for each problematic DSD predicted to fail or not fail, respectively, said training comprising minimizing a loss function, using backpropagation, with respect to deviations of Fₚ from Fₜ for each problematic DSD.

Use of Fₜ and Fₚ trains the NNHL model m to distinguish combinations of abnormal DSD parameters and abnormal environmental parameters that cause DSD failure and combinations of abnormal DSD parameters and abnormal environmental parameters that do not cause DSD failure.

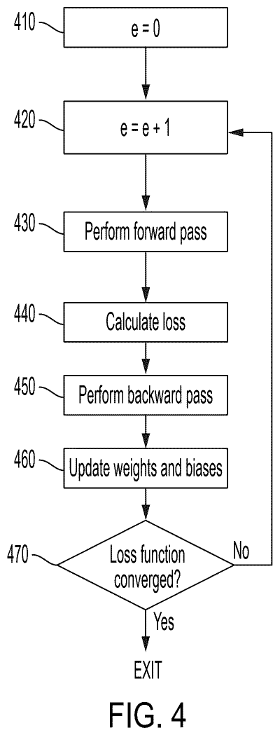

FIG. 4 describes usage of backpropagation to minimize the loss function in step 340.

Step 350 determines whether m=M. If so (Yes branch from step 350) then the method exits. If so (No branch from step 350) then the method loops back to step 320 to perform the next iteration m+1.

In one embodiment, step 340 also trains the NNHL model: to predict a failure probability of each problematic DSD and to predict Fₚ=1 or 0 in response to the predicted failure probability of each problematic DSD exceeding or not exceeding, respectively, a specified failure probability threshold.

In one embodiment, 1 each problematic environmental parameter at the identified location of each problematic DSD is within a specified distance from each problematic DSD.

In one embodiment, the one or more problematic environmental parameters are selected from the group consisting of air temperature, air humidity, air quality, ear dust composition, and combinations thereof.

In one embodiment, the one or more problematic environmental parameters are selected from the group consisting of 1 radio interference, neutral voltage, ground resistance, static electricity, physical vibration, unstable voltage, and combinations thereof.

In one embodiment, 1 the one or more abnormal DSD parameters at the identified location of each problematic DSD are selected from the group consisting of 1 DSD temperature, read/write error rates, DSD rotational speed, seek error rates, sector reallocation count, spin retry count, power-on hours, cyclic redundancy check (CRC) error count, uncorrectable sector count, and combinations thereof.

In one embodiment, 1 the locations of the DSDs are stored in a database.

FIG. 4 is a flow chart of a process that uses backpropagation to minimize the loss function in step 340 of FIG. 3, in accordance with embodiments of the present invention. The flow chart of FIG. 4, which includes steps 410-470, is an iterative process over multiple epochs with each epoch being an iteration of the iterative process and encompassing steps 420-470.

Step 410 initializes an epoch index e to zero.

Step 420 increments e by 1.

Step 430 performs a forward pass in which one or more sets of training data are fed through the neural network, layer by layer, to compute the output prediction of Fₚ for each set of the one or mor sets of training data.

Step 440 computes a loss function, which in one embodiment is (Fₚ - Fₜ)2 averaged over the one or more sets of training data.

Step 450 is a backward pass propagated backward through the neural network to compute the gradient of the loss function with respect to each weight and bias.

Step 460 updates, using the computed gradients, weights and biases in the direction that reduces the loss function.

Step 470 determines whether the loss function has converged to a minimum values within a specified loss tolerance. If so (Yes branch from step 470), then the process exits. If not (No branch from step 470), then the process loops back to step 420 to perform the next epoch e+1.

In one embodiment, the one or more sets of training data used in step 430 consists of one set of training data of the multiple sets of the training data received in step 330 of FIG. 3, so that the backpropagation iterative process is performed after each set of training data is used.

In one embodiment, the one or more sets of training data used in step 430 consists of the multiple sets of the training data received in step 330 of FIG. 3, so that the backpropagation iterative process is performed after all sets of the multiple sets of training data are used.

In one embodiment, the one or more sets of training data used in step 430 consists of more than one set of training, and less than the multiple sets of the training data, received in step 330 of FIG. 3.

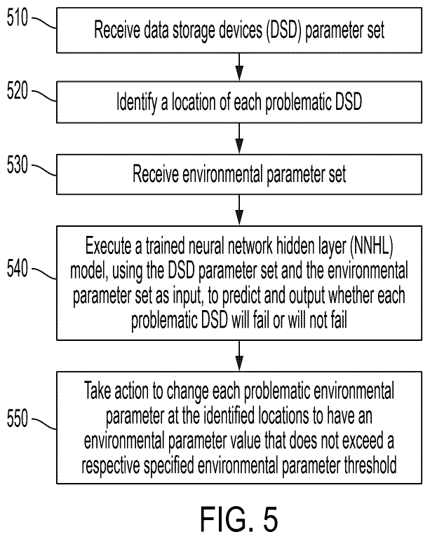

FIG. 5 is a flow chart describing a method for preventing failure of problematic data storage devices (DSDs), in accordance with embodiments of the present invention. The method of FIG. 5 includes steps 510-550.

Step 510 receives, from a DSD monitoring system that is included within DSDs and monitors the DSDs, a DSD parameter set comprising one or more problematic DSDs, one or more abnormal DSD parameters respectively associated with each problematic DSD, and an abnormal DSD parameter value that exceeds a respective specified DSD parameter threshold for each abnormal DSD parameter.

Step 520 identifies a location of each problematic DSD using, in one embodiment, the lookup map 240 of FIG. 2.

Step 530 receives, 1 from environmental sensors, an environmental parameter set comprising one or more problematic environmental parameters characterized by an abnormal environmental parameter value outside of specified range of acceptable values for each problematic environmental parameter at the identified location of each problematic DSD.

Step 540 executes a trained neural network hidden layer (NNHL) model, using the DSD parameter set and the environmental parameter set as input, to predict and output whether each of the one or more problematic DSDs will fail or will not fail, wherein said executing the trained NNHL model comprises predicting and outputting that at least one problematic DSD of the one or more problematic DSDs will fail.

Step 550, 1 in response to the NNHL model predicting and outputting that the at least one problematic DSD will fail, takes action to change each problematic environmental parameter at the identified locations to have an environmental parameter value that does not exceed the respective specified environmental parameter threshold.

For example, the NNHL model may learn, from being trained, that the combination of (i) abnormal DSD parameters of 1 sector reallocation count, write error rate, and either CRC error count or uncorrectable error count and (ii) a problematic environmental parameter of unstable voltage is likely to causes DSD failure, so that step 540 predicts that one or more problematic DSDs will fail due to the preceding combination. Accordingly, step 550 may take action to send a warning to an inspector of the power supply in the affected area in which the power supply is located to prevent the predicted DSD failure.

In one embodiment, 1 executing the trained NNHL model comprises predicting a failure probability of each problematic DSD of the at least one problematic DSD failing and predicting that the at least one problematic DSD will fail in response to the predicted failure probability of each problematic DSD of the at least one problematic DSD exceeding a respective specified failure probability threshold.

In one embodiment, each problematic environmental parameter at the identified location of each problematic DSD is within a specified distance from each problematic DSD.

In one embodiment, the one or more problematic environmental parameters are selected from the group consisting of air temperature, air humidity, air quality, ear dust composition, and combinations thereof.

In one embodiment, the one or more problematic environmental parameters are selected from the group consisting of radio interference, neutral voltage, ground resistance, static electricity, physical vibration, unstable voltage, and combinations thereof.

In one embodiment, the one or more abnormal DSD parameters at the identified location of each problematic DSD are selected from the group consisting of 1 DSD temperature, read/write error rates, DSD rotational speed, seek error rates, sector reallocation count, spin retry count, power-on hours, cyclic redundancy check (CRC) error count, uncorrectable sector count, and combinations thereof.

In one embodiment, the NNHL model is specific to a unique DSD brand and model, a unique DSD brand, a unique range of DSD storage capacity, a unique range of DSD power consumption, or a unique DSD type selected from the group consisting of hard disk drives, solid state devices, optical disc drives, and tape drives.

FIG. 6 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 6 shows the computer system 90 as a particular configuration of hardware and software, any configuration of hardware and software, as would be known to a person of ordinary skill in the art, may be utilized for the purposes stated supra in conjunction with the particular computer system 90 of FIG. 6. For example, the memory devices 94 and 95 may be portions of a single memory device rather than separate memory devices.

1 A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

11. A method for training multiple neural network hidden layer (NNHL) models to predict a failure probability of data storage devices (DSDs), said method comprising for each NNHL model:
receiving, by one or more processors of a computer system, training data comprising multiple sets of training data, each set of training data comprising: (i) a DSD parameter set comprising one or more problematic DSDs, one or more abnormal DSD parameters respectively associated with each problematic DSD, and an abnormal DSD parameter value that exceeds a respective specified DSD parameter threshold for each abnormal DSD parameter, (ii) an environmental parameter set comprising one or more problematic environmental parameters and an abnormal environmental parameter value outside of specified range of acceptable values for each problematic environmental parameter at an identified location of each problematic DSD and (iii) Fₜ=1 or 0 for each problematic DSD that failed or did not fail, respectively; and
training, by the one or more processors using the training data, the NNHL model to predict Fₚ=1 or 0 for each problematic DSD predicted to fail or not fail, respectively, said training comprising minimizing a loss function, using backpropagation, with respect to deviations of Fₚ from Fₜ for each problematic DSD;
wherein each NNHL model is specific to a unique DSD brand and model, a unique DSD brand, a unique range of DSD storage capacity, a unique range of DSD power consumption, or a unique DSD type selected from the group consisting of hard disk drives, solid state devices, optical disc drives, and tape drives.

2. The method of claim 1, wherein said training further comprises training the NNHL model: to predict a failure probability of each problematic DSD and to predict Fₚ=1 or 0 in response to the predicted failure probability of each problematic DSD exceeding or not exceeding, respectively, a specified failure probability threshold.

3. The method of claim 1, wherein each problematic environmental parameter at the identified location of each problematic DSD is within a specified distance from each problematic DSD.

4. The method of claim 1, wherein the one or more problematic environmental parameters are selected from the group consisting of air temperature, air humidity, air quality, ear dust composition, and combinations thereof.

5. The method of claim 1, wherein the one or more problematic environmental parameters are selected from the group consisting of radio interference, neutral voltage, ground resistance, static electricity, physical vibration, unstable voltage, and combinations thereof.

6. The method of claim 1, wherein the one or more abnormal DSD parameters at the identified location of each problematic DSD are selected from the group consisting of DSD temperature, read/write error rates, DSD rotational speed, seek error rates, sector reallocation count, spin retry count, power-on hours, cyclic redundancy check (CRC) error count, uncorrectable sector count, and combinations thereof.

7. The method of claim 1, wherein the locations of the DSDs are stored in a database.

8. A method for preventing failure of problematic data storage devices (DSDs), said method comprising:
receiving, by one or more processors of a computer system from a DSD monitoring system that is included within DSDs and monitors the DSDs, a DSD parameter set comprising one or more problematic DSDs, one or more abnormal DSD parameters respectively associated with each problematic DSD, and an abnormal DSD parameter value that exceeds a respective specified DSD parameter threshold for each abnormal DSD parameter;
identifying, by the one or more processors, a location of each problematic DSD;
receiving, by the one or more processors from environmental sensors, an environmental parameter set comprising one or more problematic environmental parameters characterized by an abnormal environmental parameter value outside of specified range of acceptable values for each problematic environmental parameter at the identified location of each problematic DSD,
executing, by the one or more processors, a trained neural network hidden layer (NNHL) model, using the DSD parameter set and the environmental parameter set as input, to predict and output whether each of the one or more problematic DSDs will fail or will not fail, wherein said executing the trained NNHL model comprises predicting and outputting that at least one problematic DSD of the one or more problematic DSDs will fail; and
in response to said NNHL model predicting and outputting that the at least one problematic DSD will fail, taking action to change each problematic environmental parameter at the identified locations to have an environmental parameter value that does not exceed the respective specified environmental parameter threshold.

9. The method of claim 8, wherein said executing the trained NNHL model comprises predicting a failure probability of each problematic DSD of the at least one problematic DSD failing and predicting that the at least one problematic DSD will fail in response to the predicted failure probability of each problematic DSD of the at least one problematic DSD exceeding a respective specified failure probability threshold.

10. The method of claim 8, wherein each problematic environmental parameter at the identified location of each problematic DSD is within a specified distance from each problematic DSD.

11. The method of claim 8, wherein the one or more problematic environmental parameters are selected from the group consisting of air temperature, air humidity, air quality, ear dust composition, and combinations thereof.

12. The method of claim 8, wherein the one or more problematic environmental parameters are selected from the group consisting of radio interference, neutral voltage, ground resistance, static electricity, physical vibration, unstable voltage, and combinations thereof.

13. The method of claim 8, wherein the one or more abnormal DSD parameters at the identified location of each problematic DSD are selected from the group consisting of DSD temperature, read/write error rates, DSD rotational speed, seek error rates, sector reallocation count, spin retry count, power-on hours, cyclic redundancy check (CRC) error count, uncorrectable sector count, and combinations thereof.

14. The method of claim 8, wherein the NNHL model is specific to a unique DSD brand and model, a unique DSD brand, a unique range of DSD storage capacity, a unique range of DSD power consumption, or a unique DSD type selected from the group consisting of hard disk drives, solid state devices, optical disc drives, and tape drives.

15. A computer program product, comprising one or more computer readable storage media storing computer readable program instructions, said program instructions executable by one or more processors of a computer system to cause the computer system to perform operations for preventing failure of problematic data storage devices (DSDs), said operations comprising:
receiving, by one or more processors of a computer system from a DSD monitoring system that is included within DSDs and monitors the DSDs, a DSD parameter set comprising one or more problematic DSDs, one or more abnormal DSD parameters respectively associated with each problematic DSD, and an abnormal DSD parameter value that exceeds a respective specified DSD parameter threshold for each abnormal DSD parameter;
identifying, by the one or more processors, a location of each problematic DSD;
receiving, by the one or more processors from environmental sensors, an environmental parameter set comprising one or more problematic environmental parameters characterized by an abnormal environmental parameter value outside of specified range of acceptable values for each problematic environmental parameter at the identified location of each problematic DSD,
executing, by the one or more processors, a trained neural network hidden layer (NNHL) model, using the DSD parameter set and the environmental parameter set as input, to predict and output whether each of the one or more problematic DSDs will fail or will not fail, wherein said executing the trained NNHL model comprises predicting and outputting that at least one problematic DSD of the one or more problematic DSDs will fail; and
in response to said NNHL model predicting and outputting that the at least one problematic DSD will fail, taking action to change each problematic environmental parameter at the identified locations to have an environmental parameter value that does not exceed the respective specified environmental parameter threshold.

16. The computer program product of claim 15, wherein said executing the trained NNHL model comprises predicting a failure probability of each problematic DSD of the at least one problematic DSD failing and predicting that the at least one problematic DSD will fail in response to the predicted failure probability of each problematic DSD of the at least one problematic DSD exceeding a respective specified failure probability threshold.

17. The computer program product of claim 15, wherein each problematic environmental parameter at the identified location of each problematic DSD is within a specified distance from each problematic DSD.

18. The computer program product of claim 15, wherein the one or more problematic environmental parameters are selected from the group consisting of air temperature, air humidity, air quality, ear dust composition, and combinations thereof.

19. The computer program product of claim 15, wherein the one or more problematic environmental parameters are selected from the group consisting of radio interference, neutral voltage, ground resistance, static electricity, physical vibration, unstable voltage, and combinations thereof.

20. The computer program product of claim 15, wherein the one or more abnormal DSD parameters at the identified location of each problematic DSD are selected from the group consisting of DSD temperature, read/write error rates, DSD rotational speed, seek error rates, sector reallocation count, spin retry count, power-on hours, cyclic redundancy check (CRC) error count, uncorrectable sector count, and combinations thereof.
